(19) United States
(12) Patent Application Publication
(10) Pub. No.: US 2013/0049245 A1
(43) Pub. Date: Feb. 28, 2013

(54) RESIN DISTINGUISHING APPARATUS AND RESIN DISTINGUISHING METHOD

(71) Applicant: PANASONIC CORPORATION, Osaka (JP)

(72) Inventor: Norie ARAKI, Osaka (JP)

(73) Assignee: PANASONIC CORPORATION, Osaka (JP)

(21) Appl. No.: 13/662,238

(22) Filed: Oct. 26, 2012

Related U.S. Application Data
(63) Continuation of application No. PCT/JP2011/002435, filed on Apr. 26, 2011.

(30) Foreign Application Priority Data
Apr. 27, 2010 (JP) 2010-101727

(51) Int. Cl. G01N 3/40

(52) U.S. Cl. 264/40.1; 425/169

(57) ABSTRACT

A resin discrimination device for discriminating a first resin part from a resin molded article (2) having the first resin part as a substrate and a surface member formed on the surface of the first resin part includes a hardness determination part (6) for tearing the surface member, contacting the surface of the first resin part and detecting a hardness of the first resin part.

### TECHNICAL FIELD

The instant application relates to a resin discrimination device and a resin discrimination method capable of easily discriminating resin materials.

### BACKGROUND

In recent years, with improvements in public attitudes on the global environment, huge efforts to reuse a wide range and variety of substances and materials used for manufacturing various products have been made worldwide. Likewise, rules on recycling materials are executed in Japan and it is presumed that reuse of various substances and/or materials in manufacturing products will be further required in the future. In such efforts for reuse, discrimination of various substances and/or materials of the manufactured products has been recognized to be very significant. For instance, Patent Literature 1 discloses a simple separating method of a plastic molded product to discriminate various substances and/or materials, wherein the surface hardness of the plastic molded product is measured and separated by adding a load of pencil or the like to the plastic molded product.

However, in order to improve an appearance of a plastic molded product and improve a performance of a resin, a resin substrate of the plastic molded product sometimes has a surface coated with an additional material other than the resin substrate. Further, such a surface of the resin substrate may be mixed with a plastic molded product having a non-coated surface. Therefore, the separating method of a plastic molded product of Patent Literature 1 may provide faulty discrimination that the plastic molded product is made of a material used for coating the surface of a resin substrate even when the surface of the resin substrate is coated. Consequently, it is difficult to precisely discriminate the resin used for the resin substrate.

### CITATION LIST

### Patent Literature

PTL 1; Unexamined Japanese Patent Publication No. 2008-164485

### SUMMARY

According to an aspect of the instant application, a resin discrimination device for discriminating a first resin part from a resin molded article having the first resin part as a substrate and a surface member formed on the surface of the first resin part, includes a hardness determination part to break through the surface member, contact the surface of the first resin part and detect a hardness of the first resin part.

According to another aspect of the instant application, a resin discrimination method for discriminating a first resin part from a resin molded article having the first resin part as a substrate, and a surface member formed on the surface of the first resin part, includes an impacting step of breaking through the surface member; a contacting step of contacting the surface of the first resin part after the impacting step; and a hardness determining step of detecting a hardness of the surface of the first resin part contacted in the contacting step.

In accordance with the instant application, it is possible to simply and precisely discriminate a resin as a substrate and efficiently separate and recover a resin molded article.

### BRIEF DESCRIPTION OF DRAWINGS

FIG. 1 is a schematic perspective view of a resin discrimination device according to a first exemplary embodiment;

FIG. 2A is a view showing a resin molded article according to the first exemplary embodiment;

FIG. 2B is a view showing another resin molded article according to the first exemplary embodiment;

FIG. 2C is a view showing another resin molded article according to the first exemplary embodiment;

FIG. 3A is a schematic perspective view of a resin discrimination device illustrating a condition under which the resin molded article according to the first exemplary embodiment is discriminated by the device;

FIG. 3B is a schematic view of the resin molded article according to the first exemplary embodiment illustrating a condition under which a hardness determination part penetrates a surface member of the resin molded article;

FIG. 3C is a schematic view of the resin molded article according to the first exemplary embodiment illustrating a condition under which the hardness determination part contacts a substrate of the resin molded article;

FIG. 4 is a plan view of a resin molded article showing a part thereof to which point load is applied;

FIG. 5A is a plan view of a resin molded article showing a part thereof to which point load is applied and having an impact mark thereon;

FIG. 5B is a plan view of another resin molded article showing a part thereof to which point load is applied and having an impact mark thereon;

FIG. 5C is a plan view of another resin molded article showing a part thereof to which point load is applied and having an impact mark thereon;

FIG. 6 is a flow chart showing a resin discrimination method according to the first exemplary embodiment;

FIG. 7 is a flow chart showing a resin discrimination method according to a second exemplary embodiment; and

FIG. 8 is a schematic perspective view showing a resin discrimination device according to a third exemplary embodiment.

### DETAILED DESCRIPTION

Hereinafter, a resin discrimination device and a resin discrimination method according to a first exemplary embodiment of the instant application will be described with reference to the accompanying drawings.

### First Exemplary Embodiment

Hereinafter, the first exemplary embodiment will be described in detail with reference to the drawings.

[Outline of a Resin Discrimination Device and Resin Molded Article 2]

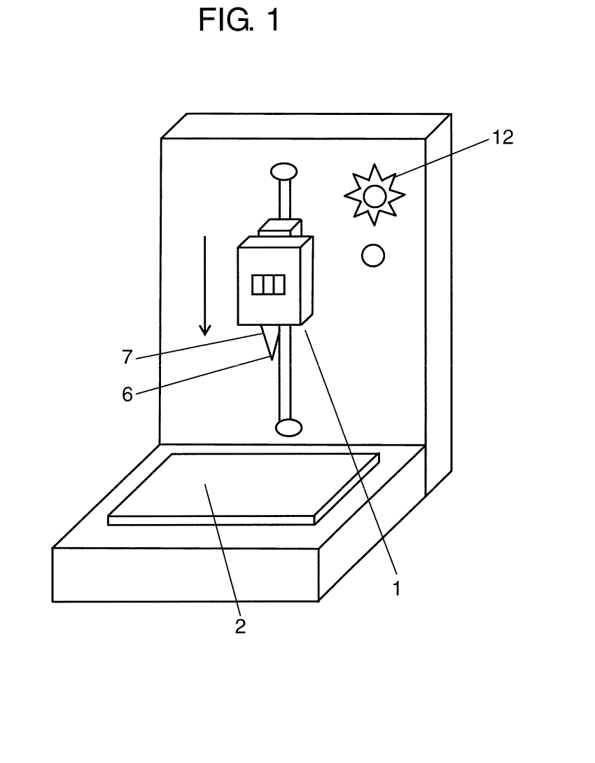

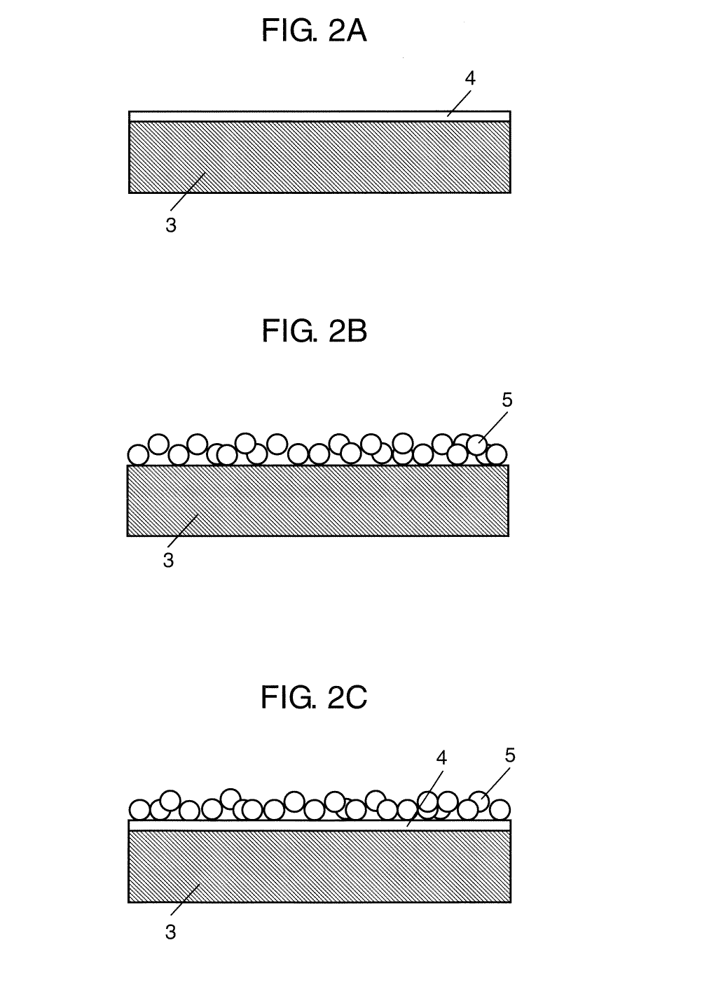

FIG. 1 is a schematic perspective view of a resin discrimination device according to a first exemplary embodiment, FIG. 2A is a view showing a resin molded article according to the first exemplary embodiment, FIG. 2B is a view showing another resin molded article according to the first exemplary embodiment, and FIG. 2C is a view showing another resin molded article according to the first exemplary embodiment.

Recently, an external housing for household appliances is formed using a resin molded article based on thin film type molding resins as a substrate. Also, the surface of such a resin molded article may be coated with a surface member in view of design or functionality thereof.

According to the first exemplary embodiment, resin molded article 2 is placed in resin discrimination device 1, as shown in FIG. 1. Resin discrimination device 1 discriminates the resin as a substrate of resin molded article 2.

With regard to resin molded article 2, first resin part 3 is coated with surface member 4 as shown in FIG. 2A, first resin part 3 is coated with surface member 5 as shown in FIG. 2B, first resin part 3 is coated with surface member 4 and further coated with surface member 5 thereon as shown in FIG. 2C.

For resin molded article 2 in FIG. 2A, the surface of first resin part 3 is coated with surface member 4 in a sheet form. Also, for resin molded article 2 in FIG. 2B, the surface of first resin part 3 is coated with foamed surface member 5. Further, for resin molded article 2 in FIG. 2C, the surface of first resin part 3 is coated with two layers of sheet type surface member 4 and foamed surface member 5.

Referring to FIG. 2A to FIG. 2C, first resin parts 3 are coated with three different surface members 4 or 5, respectively. According to the present exemplary embodiment, first resin part 3 uses resin molded article 2 having a thickness of 2 mm to 3 mm.

Also, resin molded article 2 in the present exemplary embodiment may be formed using any resin.

In addition, resin molded article 2 in the present exemplary embodiment is not particularly limited to resin molded articles for external housings.

Further, although the present exemplary embodiment has described the above three kinds of resin molded articles 2 as particular examples, other types of the resin molded articles may also be included in an aspect of use thereof.

[Configuration of Resin Discrimination Device 1]

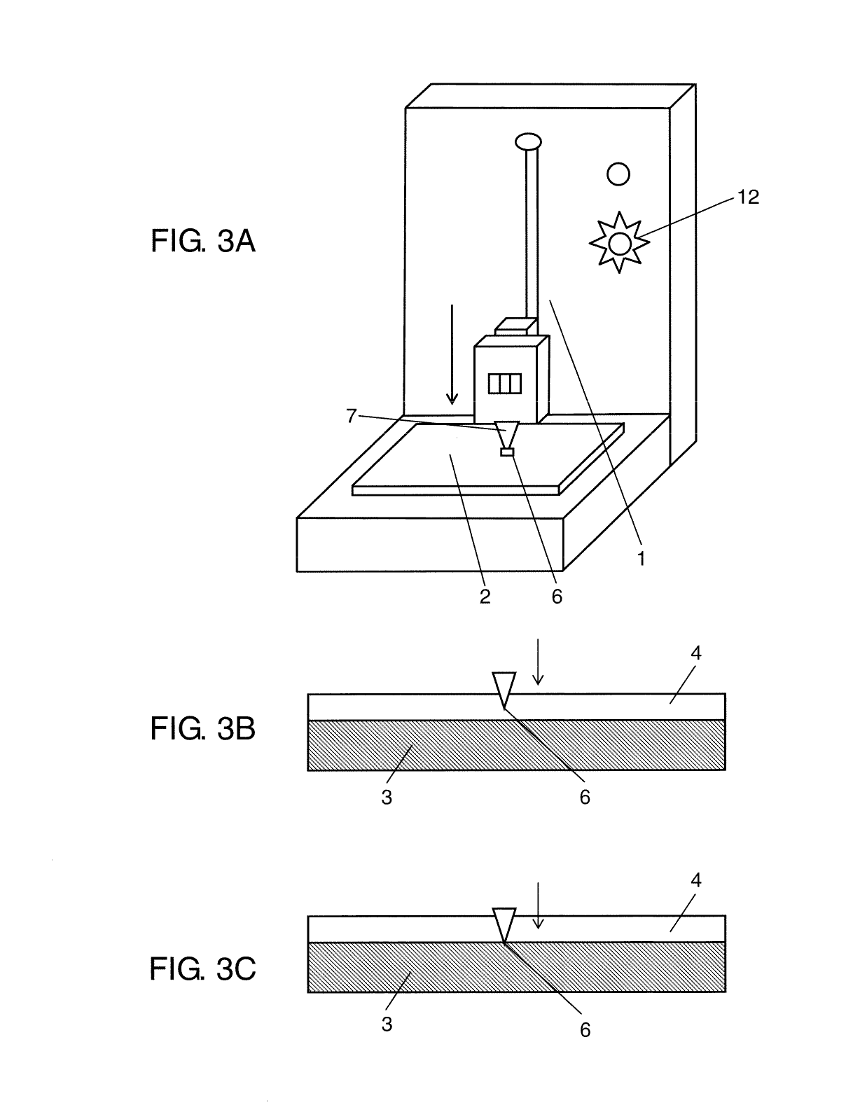

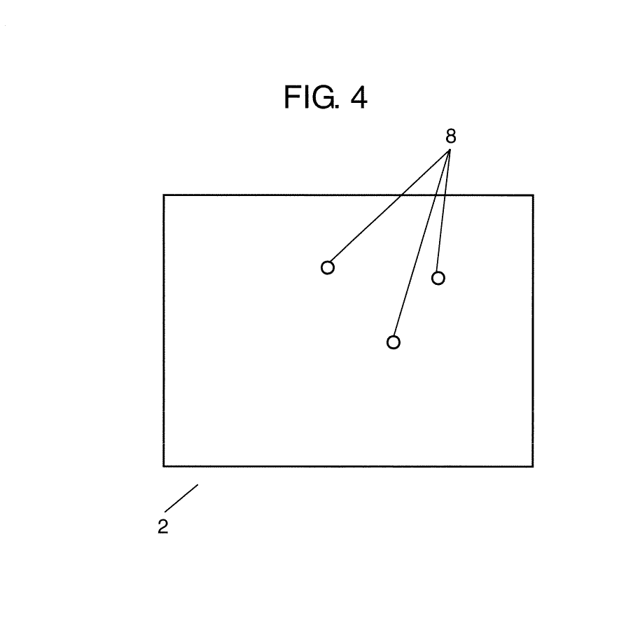

FIG. 3A is a schematic perspective view of a resin discrimination device illustrating a condition under which the resin molded article according to the first exemplary embodiment is discriminated by the device, FIG. 3B is a schematic view of the resin molded article according to the first exemplary embodiment illustrating a condition under which a hardness determination part penetrates a surface member of the resin molded article, and FIG. 3C is a schematic view of the resin molded article according to the first exemplary embodiment illustrating a condition under which the hardness determination part contacts a substrate of the resin molded article.

[Hardness Determination Part 6]

Referring to FIG. 1, resin discrimination device 1 includes hardness determination part 6.

By hardness determination part 6, a surface hardness of first resin part 3 of resin molded article 2 is determined. Based on a result of determining the surface hardness of first resin part 3, it is possible to discriminate what type of resin is used for first resin part 3.

According to the present exemplary embodiment, as shown in FIG. 3A, hardness determination part 6 comes down in a vertical direction in order to ensure that it comes into contact with a face of resin molded article 2 at a predetermined speed in a direction perpendicular thereto.

Also, a speed controller may be added to change a contact speed of hardness determination part 6 to resin molded article 2, in consideration of coating conditions or types of first resin part 3.

For instance, when a metal or urethane-based surface member is applied, its hardness is greater than that of a resin-based surface member. Thus, a surface member tearing speed when the metal or urethane-based surface member is coated is higher than that when the resin-based surface member is provided.

As shown in FIG. 3B or FIG. 3C, a front end of hardness determination part 6 tears the surface member applied to first resin part 3. Then, first resin part 3 is exposed through the torn part. That is, the front end of hardness determination part 6 contacts the exposed surface of first resin part 3. Hence, hardness determination part 6 determines a hardness of the surface of first resin part 3. In the determination of the hardness, hardness determination part 6 applies a predetermined load to first resin part 3. As a result, the hardness of first resin part 3 can be determined.

More particularly, the hardness of first resin part 3 may be measured and indicated as a numeric value, or whether the hardness is greater than a predetermined load may be determined by light emitting device 12 such as a lamp if the predetermined load is reached,.

Resin discrimination device 1 may further include a discrimination part (not shown). Such a discrimination part may automatically discriminate the type of first resin part 3 based on the determination by hardness determination part 6. Therefore, first resin part 3 can be more correctly discriminated.

First resin part 3 may include, for example, PMMA, polystyrene (PS), polycarbonate (PC), or the like. Among these resins, hardness determination part 6 can determine PMMA. If first resin part 3 is PMMA, a hardness thereof is relatively great, compared to first resin part 3 including polystyrene (PS) or polycarbonate (PC). However, resin molded article 2 having first resin part 3 based on polystyrene (PS) or polycarbonate (PC) cannot precisely determine the resin, because the hardness partially overlaps when a plurality of resin molded articles 2 are subjected to hardness determination.

Consequently, the discrimination by hardness determination part 6 alone cannot precisely discriminate first resin part 3 nor can it discriminate resin molded articles 2. Therefore, first resin part 3 is discriminated using point load part 7 to be described below.

[Point Load Part 7]

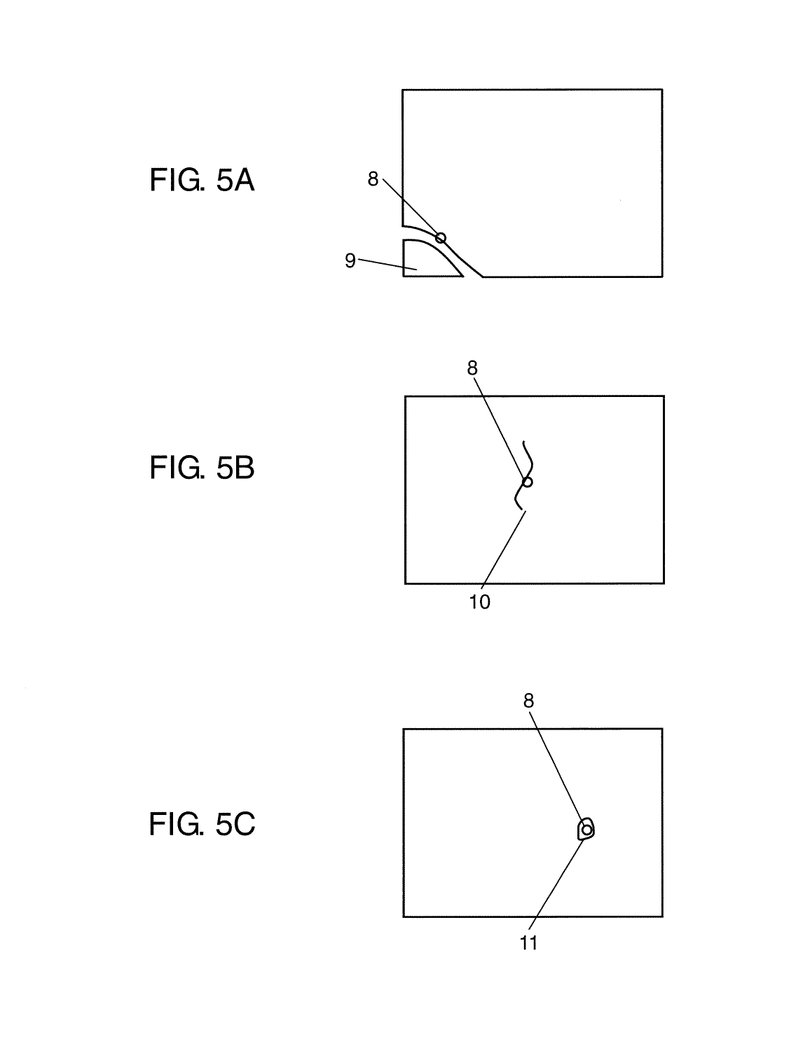

Resin discrimination device 1 in the present exemplary embodiment may further include point load part 7. Point load part 7 will be described in detail in conjunction with FIG. 3A, FIG. 4 and FIG. 5A to FIG. 5C.

FIG. 4 is a plan view of a resin molded article showing a part thereof to which point load is applied, FIG. 5A is a plan view of a resin molded article showing a part thereof to which point load is applied and having an impact mark thereon, FIG. 5B is a plan view of another resin molded article showing a part thereof to which point load is applied and having an impact mark thereon, and FIG. 5C is a plan view of another resin molded article showing a part thereof to which point load is applied and having an impact mark thereon.

As shown in FIG. 3A and FIG. 4, resin discrimination device 1 applies load to the surface of first resin part 3 using point load part 7. By applying a predetermined load thereto, a front end of point load part 7 bumps against the surface of first resin part 3 at a high speed.

As a result, a force of the load applied by point load part 7 is focused on a point of the surface of first resin part 3. Accordingly, load point 8 of the surface of first resin part 3, to which the load is applied, as shown in FIG. 4, has specified impact marks depending on types of first resin part 3, with reference to load point 8, as shown in FIG. 5A to FIG. 5C. Because of such formed impact marks, morphologies of the impact marks in first resin part 3 can be observed with the naked eye.

The formed impact marks may include, for example, “breakage 9” as shown in FIG. 5A, “crack 10” as shown in FIG. 5B, “white turbidity 11” as shown in FIG. 5C, or the like. Based on whether an impact mark is present or not, the type of first resin part 3 not discriminated by hardness determination part 6 can be further discriminated.

Types of the impact mark are not exclusively determined by resin materials alone. Instead, the impact marks may be different due to mixing conditions of a resin material or the presence or absence of additives, even when the same resin material is used.

For instance, polystyrene (PS) or polycarbonate (PC) cannot be discriminated by hardness determination part 6. However, using point load part 7, it is possible to easily discriminate them. Polystyrene (PS) has impact marks such as “breakage 9,” “crack 10,” “white turbidity 11,” or the like, formed thereon using point load part 7. Meanwhile, polycarbonate (PC) has a simple impact mark such as a hole formed by point load part 7 to pierce the same, however, other impact marks such as “breakage 9,” “crack 10,” “white turbidity 11,” or the like, are not formed thereon.

Accordingly, polystyrene (PS) and polycarbonate (PC) may be easily discriminated by the presence or absence of impact marks described above.

Load application by point load part 7 may be manually set to start after completing the hardness determination by hardness determination part 6. Alternatively, load application may automatically start immediately after the hardness determination is completed.

Load may be further applied to first resin part 3, which hardness determination part 6 is able to discriminate, by point load part 7, so as to more precisely discriminate first resin part 3 based on the presence of impact marks and types thereof. For example, if load is applied using point load part 7 after determining a hardness of PMMA through hardness determination part 6, such PMMA may have impact marks such as “breakage 9,” “crack 10,” “white turbidity 11,” or the like.

Second discrimination part may be further included to detect the impact mark formed on first resin part 3 and discriminate the type of first resin part 3. As a result, the type of first resin part 3 may be more precisely discriminated.

[Resin Discrimination Method]

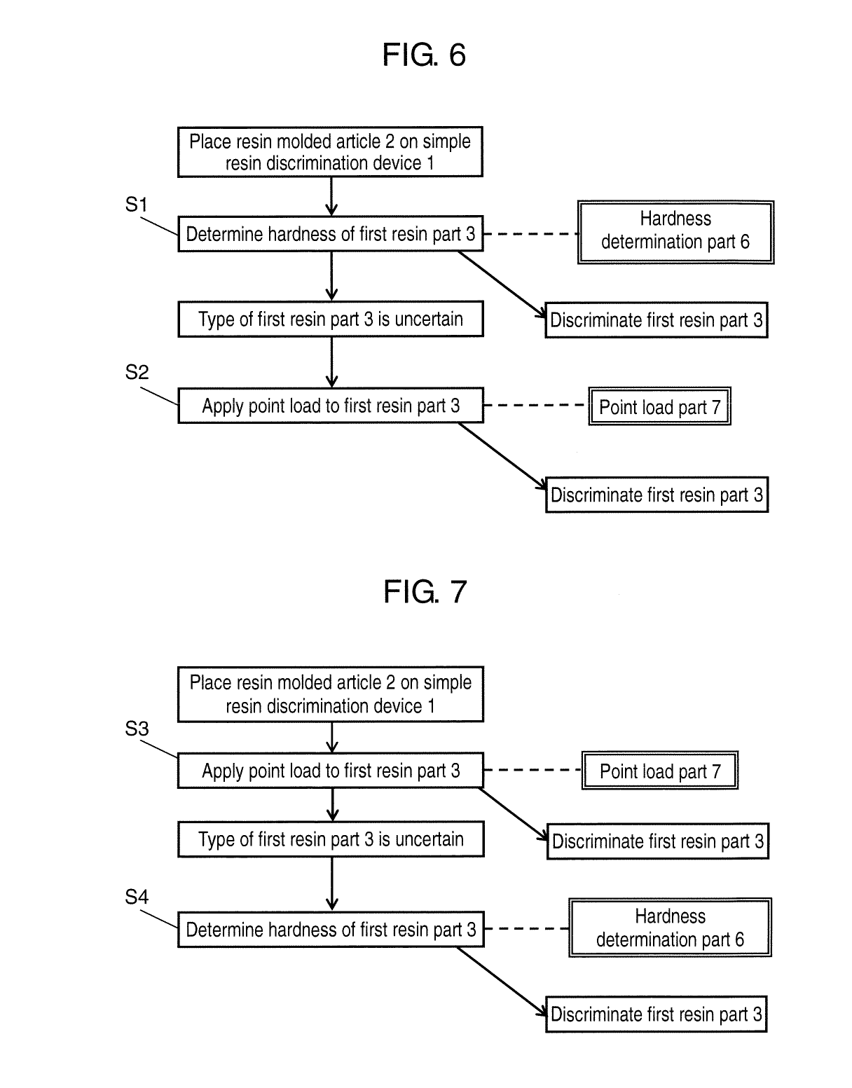

FIG. 6 is a flow chart showing a resin discrimination method according to the first exemplary embodiment.

Referring to FIG. 6, a rectangular frame outlined in a single line indicates each of steps to discriminate first resin part 3. A rectangular frame outlined in a double line shows each part of resin discrimination device 1, which is required to discriminate first resin part 3 in each step.

As shown in FIG. 6, the resin discrimination method using resin discrimination device 1 includes a hardness determining step (referred to in brief as “S1” in the drawings; hereinafter, the same shall apply) for determining the hardness of first resin part 3 and point loading step “S2” of applying point load to first resin part 3.

More particularly, S1 includes an impacting step of tearing surface member 4 or surface member 5 coated on the surface of first resin part 3, a contacting step of contacting the surface of first resin part 3 after the impacting step, and a hardness determining step of determining surface hardness of first resin part 3 contacted in the contacting step.

According to the above resin discrimination method, it is possible to precisely discriminate the type of first resin part 3 as a substrate and efficiently discern resin molded article 2, regardless of the presence or absence of surface member 4 or surface member 5.

[Hardness Determining Step]

First, resin molded article 2 is placed in resin discrimination device 1.

Next, a contact speed of hardness determination part 6 is controlled depending on coating conditions of resin molded article 2.

Following this, hardness determination part 6 moves in a direction perpendicular to a face of resin molded article 2 at a predetermined speed and contacts the surface of resin molded article 2 in a vertical direction. Then, it tears surface member 4 coated on a molded thin resin. Further, it contacts the surface of first resin part 3 as a substrate. Alternatively, when first resin part 3 does not have surface member 4 or surface member 5 coated thereon, hardness determination part 6 may directly contact the surface of first resin part 3 as the substrate.

Next, after contacting, hardness determination part 6 may apply a predetermined load to the surface of first resin part 3, to determine the hardness (S1).

Subsequently, based on a result of the hardness determination, first resin part 3 may be approximately discriminated.

For instance, when reaching a predetermined standard hardness which was previously input, whether the hardness of first resin part is greater or less than the standard hardness may be determined, while operating light emitting device 12 such as a lamp to emit light.

More particularly, in order to discriminate the type of first resin part 3, first discriminating step of discriminating the type of first resin part 3 based on the measured hardness may be further included.

By discriminating first resin part 3 through the above steps, it is possible to efficiently discern resin molded article 2.

Meanwhile, for resin molded article 2 having first resin part 3 which cannot be determined by hardness determination part 6, first resin part 3 can be discriminated through the point loading step.

[Point Loading Step]

In step S2, with regard to first resin part 3 in which first resin part 3 cannot be determined according to the hardness determination using hardness determination part 6, it is possible to discriminate a resin contained in first resin part 3 by further applying the point load in point loading step. By observing an impact mark formed during point loading step with the naked eye, the type of first resin part 3 can be precisely discriminated.

Further, in order to more precisely discriminate the type of first resin part 3, second discriminating step including detecting impact given through point load part 7 to discriminate the type of first resin part 3 may be further included.

### Second Exemplary Embodiment

Hereinafter, a second exemplary embodiment will be described in detail with reference to the drawings.

FIG. 7 is a flow chart showing a resin discrimination method according to the second exemplary embodiment.

With regard to the resin discrimination method according to the second exemplary embodiment, aspects different from those of the resin discrimination method according to the first exemplary embodiment are described but other explanations will be omitted.

As shown in FIG. 7, the resin discrimination method according to the second exemplary embodiment may start operation of hardness determination part 6 after operation of point load part 7.

In step S3, first, an impact mark is formed on first resin part 3 by impact given through point load part 7.

In step S4, first resin part 3 not discriminated from the impact mark caused by point load part 7 may be subjected to hardness determination using hardness determination part 6 in a further step.

When measuring the hardness, arrangement is altered to enable a front end of hardness determination part 6 to contact a site other than the impact mark formed on first resin part 3.

Hence, it is possible to prevent a decrease in hardness caused by “breakage 9,” “crack 10,” “white turbidity 11,” or the like, formed on first resin part 3, thereby more exactly determining first resin part 3.

### Third Exemplary Embodiment

Hereinafter, a third exemplary embodiment will be described in detail with reference to the drawings.

With regard to resin discrimination device 1 according to the third exemplary embodiment, aspects different from those of resin discrimination device 1 according to the first exemplary embodiment are described but other explanations will be omitted.

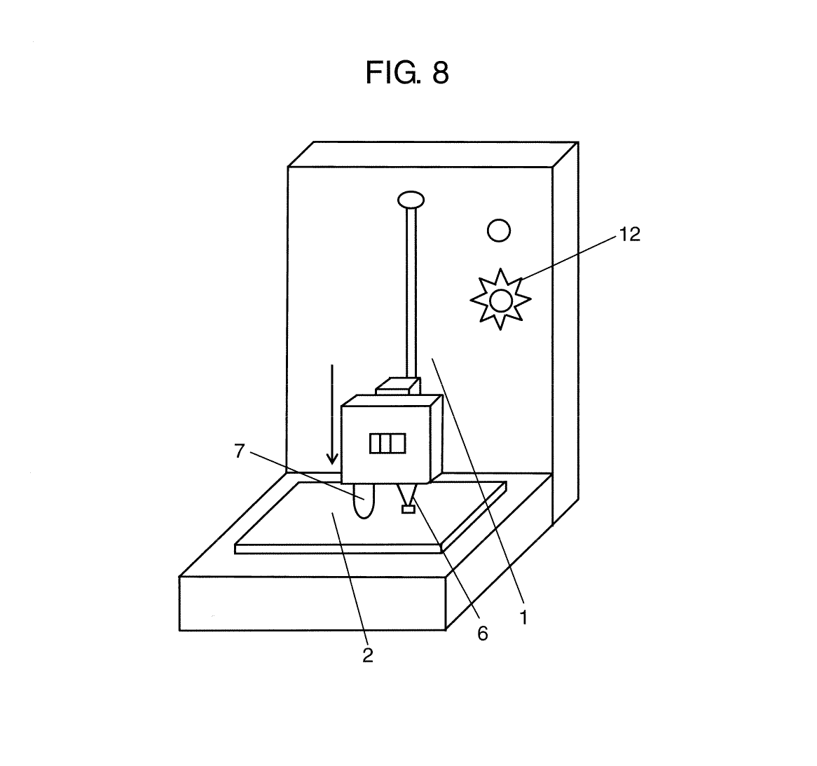

FIG. 8 is a schematic perspective view showing the resin discrimination device according to the third exemplary embodiment.

Unlike first and second exemplary embodiments, resin discrimination device 1 in the present exemplary embodiment includes separate hardness determination part 6 and point load part 7, respectively.

Accordingly, it is possible to perform hardness determination coincident with point load application and to decrease a discrimination time to discriminate first resin part 3.

Moreover, although the present exemplary embodiment describes hardness determination coincident with point load application, point load application may be performed after the hardness determination, or hardness determination may be performed after the point load application.

[Summarization]

Specified aspects in the above exemplary embodiments are described below. Meanwhile, inventions described in the above exemplary embodiments are not particularly limited to the following. Also, contents in parentheses of respective configurations correspond to particular embodiments of such configurations. These configurations are not particularly limited to the particular embodiments.

Hereinbefore, as described in first to third exemplary embodiments, resin discrimination device 1 in the present exemplary embodiment discriminates first resin part 3 from resin molded article 2 which has first resin part 3 as a substrate, and surface member 4 or surface member 5 formed on the surface of first resin part 3. Resin discrimination device 1 may be provided with hardness determination part 6 to tear surface member 4 or surface member 5, contact the surface of first resin part 3 and detect a hardness of first resin part 3.

Therefore, in the discrimination of first resin part 3, the hardness may be determined regardless of surface conditions of first resin part 3. Moreover, first resin part 3 may be precisely discriminated based on a difference in hardness, so as to easily recover high quality materials for recycling.

With regard to resin discrimination device 1 in the present exemplary embodiment, first discrimination part capable of discriminating the type of first resin part 3 based on the hardness of first resin part 3 measured by hardness determination part 6 may be further included.

Therefore, the type of first resin part 3 may be approximately discriminated based on more precise hardness determination.

Resin discrimination device 1 in the present exemplary embodiment may further include point load part 7 to apply point load to the surface of first resin part 3.

Therefore, in the discrimination of first resin part 3, point load may be applied regardless of surface conditions of first resin part 3. In addition, first resin part 3 can be precisely discriminated based on a difference in results of point load, to hence easily recover high quality materials for recycling.

Additionally, point load part 7 of resin discrimination device 1 in the present exemplary embodiment may form an impact mark on the surface of first resin part 3.

Therefore, since the impact mark formed by point load part 7 remains during the discrimination of first resin part 3, first resin part 3 can be observed and discriminated with the naked eye. Moreover, high quality materials for recycling can be easily recovered.

With regard to resin discrimination device 1 in the present exemplary embodiment, point load part 7 may further include second discrimination part to detect impact given through point load part 7 to thus discriminate the type of first resin part 3.

Therefore, the type of first resin part 3 can be more precisely discriminated.

For resin discrimination device 1 in the present exemplary embodiment, point load part 7 may be substantially identical to hardness determination part 6.

Therefore, when discriminating first resin part 3, only a driving part of resin discrimination device 1 may be provided to hence make it possible to manufacture a compact discrimination device. Moreover, high quality materials for recycling may be easily recovered.

Furthermore, the resin discrimination method in the present exemplary embodiment may include discriminating first resin part 3 from resin molded article 2 which has first resin part 3 as a substrate, and surface member 4 or surface member 5 formed on the surface of first resin part 3. This resin discrimination method includes an impacting step of tearing surface member 4 or surface member 5, a contacting step of contacting the surface of first resin part 3 after the impacting step, and a hardness determining step of detecting a hardness of the surface of first resin part 3 contacted in the contacting step.

Therefore, the hardness can be determined during the discrimination of first resin part 3, regardless of surface conditions of first resin part 3. Moreover, since first resin part 3 is precisely discriminated by a difference in hardness, high quality materials for recycling can be easily recovered.

The resin discrimination method in the present exemplary embodiment may further include a first discriminating step of discriminating the type of first resin part 3 based on the hardness of first resin part 3 measured in the hardness determining step.

Therefore, the type of first resin part 3 can be roughly classified based on more accurate hardness determination.

The resin discrimination method in the present exemplary embodiment may further include a point loading step of applying point load to the surface of first resin part 3.

Therefore, when discriminating first resin part 3, point load may be applied regardless of surface conditions of first resin part 3. Further, since first resin part 3 is precisely discriminated based on a difference in results of point load, high quality materials for recycling can be easily recovered.

In addition, with regard to the resin discrimination method in the present exemplary embodiment, the point loading step may further include a second discriminating step of detecting impact by point load part 7, to thus discriminate the type of first resin part 3.

Therefore, the type of first resin part 3 can be more precisely discriminated.

With regard to the resin discrimination method in the present exemplary embodiment, the point loading step may be performed after the hardness determination wherein a surface hardness of first resin part 3 is detected by the hardness determining step.

Therefore, for the discrimination of first resin part 3, it is possible to precisely discriminate first resin part 3 based on a difference in results of first resin part 3 when point load is applied after measuring the hardness, even though the same hardness is given. Moreover, by precisely discriminating first resin part 3, high quality materials for recycling can be easily recovered among materials having similar characteristics.

With regard to the resin discrimination method in the present exemplary embodiment, hardness determination part 6 may be operated after applying point load to first resin part 3 by point load part 7.

Therefore, for the discrimination of first resin part 3, it is possible to precisely determine first resin part 3 based on a difference in hardness of first resin part when the hardness is measured after applying point load, even though the same results are given. Moreover, by precisely discriminating first resin part 3, high quality materials for recycling can be easily recovered among materials having similar characteristics.

Furthermore, with regard to the resin discrimination method in the present exemplary embodiment, the point loading step may be performed in coincidence with the hardness determining step.

Therefore, when first resin part 3 is discriminated, results of hardness and application by point load can be obtained at substantially the same time and, in addition, first resin part 3 can be precisely discriminated in a short time, based on a difference in results between the hardness and the point load. Moreover, high quality material for recycling can be easily recovered.

1. A resin discrimination device for discriminating a first resin part from a resin molded article having the first resin part as a substrate and a surface member formed on the surface of the first resin part, the device comprising:
a hardness determination part for breaking through the surface member, contacting the surface of the first resin part and detecting a hardness of the first resin part.

2. The device according to claim 1, further comprising a first discrimination part for discriminating a type of the first resin part, based on the hardness of the first resin part measured by the hardness determination part.

3. The device according to claim 1, further comprising a point load part for applying point load to the surface of the first resin part.

4. The device according to claim 2, wherein the point load part forms an impact mark on the surface of the first resin part.

5. The device according to claim 3, wherein the point load part further comprises a second discrimination part for detecting an impact given by the point load part and discriminating a type of the first resin part.

6. The device according to claim 3, wherein the point load part is identical to the hard determination part.

7. A resin discrimination method for discriminating a first resin part from a resin molded article having the first resin part as a substrate and a surface member formed on the surface of the first resin part, the method comprising:
an impacting step of breaking through the surface member;
a contacting step of contacting the surface of the first resin part after the impacting step; and
a hardness determining step of determining a hardness of the surface of the first resin part contacted in the contacting step.

8. The method according to claim 7, further comprising a first discriminating step of discriminating a type of the first resin part based on the hardness of the first resin part measured in the hardness determining step.

9. The method according to claim 7, further comprising a point loading step of applying point load to the surface of the first resin part.

10. The method according to claim 7, wherein the point load step further comprises a second discriminating step of detecting impact given by the point load part and discriminating a type of the first resin part.

11. The method according to claim 9, wherein the point loading step is operated after measuring a hardness of the first resin part in the hardness determining step.

12. The method according to claim 9, wherein the point loading step is operated after the hardness determination that detects a hardness of the surface of the first resin part in the hardness determining step.

13. The method according to claim 9, wherein the point loading step is coincident with the hardness determining step.
